(19) United States
(12) Patent Application Publication
(10) Pub. No.: US 2026/0001604 A1
(43) Pub. Date: Jan. 1, 2026

(54) AIR SPRINGS FOR BICYCLE COMPONENTS

(71) Applicant: SRAM, LLC, CHICAGO, IL (US)

(72) Inventor: CHARLES DUNLAP, COLORADO SPRINGS, CO (US)

(73) Assignee: SRAM, LLC, CHICAGO, IL (US)

(21) Appl. No.: 19/242,576

(22) Filed: Jun. 18, 2025

Related U.S. Application Data
(60) Provisional application No. 63/664,462, filed on Jun. 26, 2024.

(51) Int. Cl. B62J 1/06; B62J 1/08; B62K 25/08

(52) U.S. Cl. CPC B62J 1/06; B62J 1/08; B62K 25/08; B62K 2201/08

(57) ABSTRACT

Air springs for bicycle components are described herein. An example air spring includes a tube, a first sealhead coupled to the tube, a second sealhead coupled to the tube such that a sealed pressure chamber is formed in the tube between the first and second sealheads, and a seal coupled to the second sealhead. The second sealhead and the tube are coupled along an axial interface locking length. The tube has a vent port. The seal is spaced from the vent port by a port seal gap that is less than the axial interface locking length such that as the second sealhead is being decoupled from the tube, the seal loses sealing contact with the inner surface to enable at least a portion of the sealed pressure chamber to be equalized with atmospheric air before the second sealhead is fully decoupled from the tube.

This application claims the benefit of U.S. Provisional Patent Application 63/664,462, filed Jun. 26, 2024, the contents of which are hereby incorporated by reference in its entirety.

### FIELD OF THE DISCLOSURE

This disclosure relates generally to bicycle components and, more specifically, to air springs for bicycle components.

### BACKGROUND

Bicycles are known to have suspension components. Suspension components are used for various applications, such as cushioning impacts, vibrations, or other disturbances imparted to the bicycle during use. These suspension components include rear and/or front wheel suspension components. Bicycles are also known to have height adjustable seat posts. A height adjustable seat post can be used to adjust a riding height of the seat while riding the bicycle. Suspension components and height adjustable seats posts often include an air spring, which is used to return the component to its original or extended state.

### SUMMARY

An example air spring for a bicycle component disclosed herein includes a tube having a first end and a second end opposite the first end, a first sealhead coupled to the tube at or near the first end, and a second sealhead coupled to the tube at or near the second end such that a sealed pressure chamber is formed in the tube between the first and second sealheads. The second sealhead and the tube are coupled along an axial interface locking length. The air spring also includes a seal coupled to the second sealhead and in sealing contact with an inner surface of the tube. The tube has a vent port extending between an inner surface and an outer surface of the tube. The seal is spaced from the vent port by a port seal gap that is less than the axial interface locking length such that as the second sealhead is being decoupled from the tube, the seal loses sealing contact with the inner surface to enable at least a portion of the sealed pressure chamber to be equalized with atmospheric air before the second sealhead is fully decoupled from the tube.

Another example air spring for a bicycle component disclosed herein includes a tube having a first end and a second end opposite the first end. A first section of the tube has a first inner diameter, and a second section of the tube adjacent the second end has a second inner diameter that is larger than first inner diameter. The air spring includes a first sealhead coupled to the tube at or near the first end and a second sealhead coupled to the tube at or near the second end such that a sealed pressure chamber is formed in the tube between the first and second sealheads. The second sealhead and the tube are coupled along an axial interface locking length. The air spring also includes a seal coupled to the second sealhead and in sealing contact with an inner surface of the tube along the first section. The tube has a vent port located along the second section. The seal is axially spaced from the second section by a port seal gap that is less than the axial interface locking length such that as the second sealhead is being decoupled from the tube, the seal loses sealing contact with the inner surface to enable the sealed pressure chamber to be depressurized.

Another example an air spring for a bicycle component disclosed herein includes a tube having a first end and a second end opposite the first end, a first sealhead coupled to the tube at or near the first end, and a second sealhead coupled to the tube at or near the second end such that a sealed pressure chamber is formed in the tube between the first and second sealheads. The second sealhead is coupled to the tube along an axial interface locking length. The air spring includes a piston in the sealed pressure chamber. The piston divides the sealed pressure chamber into a first chamber and a second chamber. The airs spring includes a rod coupled to the piston and extending through the second sealhead. The piston and the rod are movable between a bottom-out position and a top-out position. Also, the air spring includes a piston seal coupled to the piston and in sealing contact with an inner surface of the tube. The inner surface of the tube has a recess between the piston seal and the second sealhead. The piston seal is axially spaced from the recess by a seal gap when the piston is in the top-out position. The seal gap is less than the axial interface locking length such that as the second sealhead is being decoupled from the tube, the piston seal at least partially overlaps with the recess and loses sealing contact with the inner surface of the tube to allow airflow from the first chamber to the second chamber before the second sealhead is fully decoupled from the tube.

### BRIEF DESCRIPTION OF THE DRAWINGS

FIG. 1 is a side view of an example bicycle that may employ any of the example air springs and/or bicycle components having air springs disclosed herein.

FIG. 2 is a side view of an example height adjustable seat post with an example air spring in a fully extended position.

FIG. 3 is a side view of the example height adjustable seat post of FIG. 2 in a partially contracted position.

FIG. 4 is a cross-sectional view of the example height adjustable seat post of FIG. 2 in the fully extended position.

FIG. 5 is a cross-sectional view of the example height adjustable seat post of FIG. 3 in the partially contracted position.

FIG. 6 is an enlarged view of the callout of FIG. 5 showing an example piston assembly in the example air spring of the example height adjustable seat post.

FIG. 7 is a side view of the example air spring of FIG. 2 as removed from the other components of the height adjustable seat post.

FIG. 8 is an enlarged view of a lower portion of the example air spring of FIG. 7 showing an example lower sealhead and an example vent port.

FIG. 9 shows the example lower sealhead of FIG. 8 as being unscrewed and air pressure being vented from the vent port.

FIG. 10 is an enlarged cross-sectional view showing the inside of the air spring of FIG. 7 with the example lower sealed in a fully coupled or fully screwed position.

FIG. 11 is an enlarged cross-sectional view similar to FIG. 10 and showing the example lower sealhead as partially unscrewed from the example tube.

FIG. 12 is a side view of the example tube of the example air spring of FIG. 7.

FIG. 13 is a cross-sectional view of the example tube taken along line A-A of FIG. 12.

FIG. 14 is a side view of the example tube of the example air spring of FIG. 7 shown at 90° to the orientation shown in FIG. 12.

FIG. 15 is a cross-sectional view of the example tube taken along line B-B of FIG. 14.

FIG. 16 is an enlarged view of the callout of FIG. 13.

FIG. 17 is an enlarged view of the callout of FIG. 15.

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Some bicycle components, such as suspension components and height adjustable seat posts, include an air spring. An air spring may include a cylindrical tube that has a sealed pressure chamber. The tube is sealed at the two ends by first and second sealheads. In some examples, a valve (e.g., a Schrader valve) is incorporated into the first sealhead and can be used to add pressurized air (or another fluid) into the sealed pressure chamber and/or evacuate air from the sealed pressure chamber. The air spring includes a piston that is disposed in the sealed pressure chamber and divides the sealed pressure chamber into first and second chambers (sometimes referred to as positive and negative chambers). The air spring also includes a rod that is coupled to the piston and extends outward through the second sealhead. When the rod is pushed into or toward the tube (and/or the tube is pushed toward the rod), the rod pushes the piston toward one of the ends of the tube, which increases the pressure in the positive chamber and decreases the pressure in the negative chamber. When the force on the rod is reduced or released, the pressure differential causes the piston to move in the opposite direction and therefore push the rod back to its original or extended state. As mentioned above, air springs are commonly used in suspension components, such as front forks and rear shock absorbers. Air springs are also used in height adjustable seat posts, often referred to as dropper seat posts.

Air springs often need to be disassembled or taken apart for maintenance or repair. Typically, before a person begins to disassemble the air spring, it is recommended that the person depressurize the sealed chamber to ease the disassembly process. The person can open the valve in the first sealhead to depressurize the sealed chamber. Then, once the sealed chamber is depressurized, the person can continue to remove one or both of the sealheads and remove the piston from the tube. However, some people may forget or choose not to follow proper procedures to use the valve to depressurize the sealed chamber prior to disassembling the air spring. When the person begins to loosen certain parts, the highly pressurized sealed chamber can result in parts being ejected from the air spring at a high velocity, which can cause damage to the parts of the air spring and/or potential impact to persons in the vicinity.

Disclosed herein are example air springs that include features to automatically vent and/or depressurize the sealed chamber when one of the sealheads is being removed and before the sealhead is completely detached from the tube. This depressurization eliminates the risk of parts being ejected from the tube under high pressure. This automatic depressurization also reduces disassembly time and makes disassembly easier.

An example air spring disclosed herein includes a tube having a first end sealed by a first sealhead and a second end sealed by a second sealhead. The interior of the tube defines a sealed chamber that is filled with pressurized air (or another fluid). The air spring includes a piston in the sealed pressure chamber. The piston is sealed against the inner surface of the tube by a piston seal (e.g., an o-ring), and therefore divides the sealed chamber into two chambers, sometimes referred to as positive and negative chambers. The air spring includes a rod that is coupled to the piston and extends outward through the second sealhead. The second sealhead is coupled to the tube along an axial interface locking length. In some examples, the second sealhead is threadably coupled to the tube. The amount of threaded overlap defines the axial interface locking length. Anywhere along the axial interface locking length the second sealhead is still axially coupled to the tube. The second sealhead is sealed against the inner surface of the tube by a seal (e.g., an o-ring). The tube has a vent port near the second end. The vent port is a hole or channel between the inner surface and an outer surface of the tube. The vent port is located in a larger diameter section of the tube near the second end where the internal threads are located. When the second sealhead is fully coupled (fully screwed into) the tube, the seal is above the enlarged portion and remains in full circumferential sealing contact with the inner surface of the tube, which prevents the pressurized air from escaping from the second end of the tube. However, when the second sealhead is partially unscrewed from the tube, the seal is moved into the larger diameter section of the tube and loses sealing contact with the inner surface. This allows pressurized air in the sealed chamber to flow through the vent port and out into the atmosphere. As such, the sealed chamber quickly depressurizes and/or otherwise equalizes with atmospheric pressure. Further, in some examples, the tube has a bypass recess, such as a dimple or groove, formed on the inner surface of the tube. When the second sealhead is partially unscrewed from the tube, the piston moves to a position where the piston seal at least partially overlaps with the recess and therefore allows airflow from the positive chamber to the negative chamber. As such, all of the air in the sealed chamber can be vented out of the vent port. The air spring is configured such that the spacing between the seal and the vent port, and the spacing between the piston seal and the recess, are less than the axial interface locking length, such that the seals lose sealing contact with the tube and therefore allow venting before the second sealhead is fully detached or unscrewed from the tube. Thus, by the time the second sealhead is fully axially detached from the tube, the sealed chamber has already been depressurized. As a result, there is little or no risk of the second sealhead and/or other parts being ejected from the tube. Not only does this design significantly improve access to serviceability, but it also eases the disassembly process and reduces disassembly time.

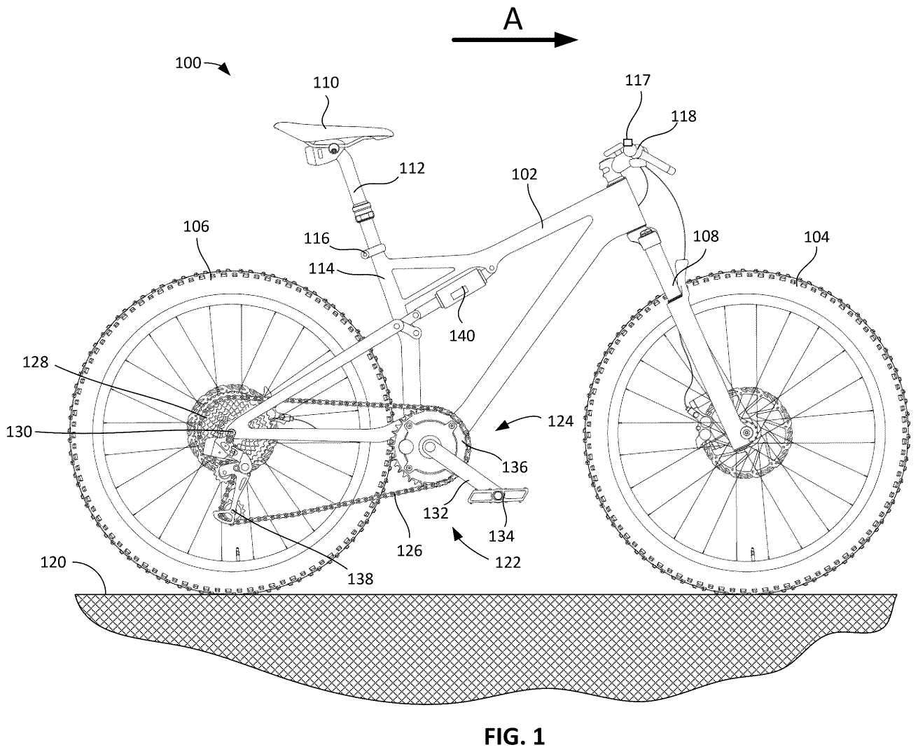

Turning now to the figures, FIG. 1 illustrates one example of a human powered vehicle on which the example air springs and bicycle components disclosed herein can be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A. The bicycle 100 is shown on a riding surface 120. The riding surface 120 may be any riding surface such as the ground (e.g., a dirt path, a sidewalk, a street, etc.), a man-made structure above the ground (e.g., a wooden ramp), and/or any other surface.

In the illustrated example of FIG. 1, the bicycle 100 includes a seat 110 (sometimes referred to as a saddle) coupled to the frame 102 (e.g., near the rear end of the frame 102 relative to the forward direction A) via a seat post 112. In the illustrated example, the seat post 112 is coupled to a seat tube 114 of the frame 102. In some examples, the seat post 112 is coupled to the seat tube 114 by a clamp 116 that surrounds the opening in the seat tube 114. In some examples, the seat post 112 is height adjustable to raise or lower the seat 110. In some examples, the bicycle 100 includes a seat post actuation button 117 to control the seat post 112, example operations of which are disclosed in further detail herein. The bicycle 100 also includes handlebars 118 coupled to the front fork 108 (e.g., near a forward end of the frame 102 relative to the forward direction A) for steering the bicycle 100. In some examples, the seat post actuation button 117 is mounted on the handlebars 118 to enable a rider to interact with the seat post actuation button 117 while riding the bicycle 100.

In the illustrated example, the bicycle 100 has a drivetrain 122 that includes a crank assembly 124. The crank assembly 124 is operatively coupled via a chain 126 to a sprocket assembly 128 mounted to a hub 130 of the rear wheel 106. The crank assembly 124 includes at least one, and typically two, crank arms 132 and pedals 134, along with at least one front sprocket, or chainring 136. A rear gear change device 138, such as a derailleur, is disposed at the rear wheel 106 to move the chain 126 between different sprockets of the sprocket assembly 128. Additionally or alternatively, the bicycle 100 may include a plurality of front chainrings and a front gear change device to move the chain 126 between the plurality of chainrings.

The example bicycle 100 can include a suspension system having one or more suspension components. In the illustrated example, the bicycle 100 includes a rear suspension component 140. In this example, the rear suspension component 140 is implemented as or includes a shock absorber, which can include a spring (e.g., an air spring) and a damper. In some examples, the front fork 108 is also implemented as a front suspension component. For example, a spring (e.g., an air spring) can be integrated into one of the legs and a damper can be integrated into the other leg. The front fork 108 and the rear suspension component 140 absorb shocks and vibrations while riding the bicycle 100 (e.g., when riding over rough terrain). In other examples, the front fork 108 and/or the rear suspension component 140 may be integrated into the bicycle 100 in other configurations or arrangements. In some examples, the seat post 112 is also considered a suspension component. Suspension components and sea posts often include air springs, which are used to return the component to a certain position or length. Disclosed herein are example air springs that can be implemented in various bicycle components, such as the seat post 112, the front fork 108, and/or the rear suspension component 140.

While the example bicycle 100 depicted in FIG. 1 is a type of mountain bicycle, the example air spring and bicycle components disclosed herein can be implemented on other types of bicycles. For example, the example air spring and bicycle components disclosed herein may be used on road bicycles, as well as bicycles with mechanical (e.g., cable, hydraulic, pneumatic, etc.) and non-mechanical (e.g., wired, wireless) drive systems. The example air spring and bicycle components disclosed herein may also be implemented on other types of two-wheeled, three-wheeled, and four-wheeled human powered vehicles. Further, the example air spring and bicycle components disclosed herein can be used on other types of vehicles, such as motorized vehicles (e.g., a motorcycle).

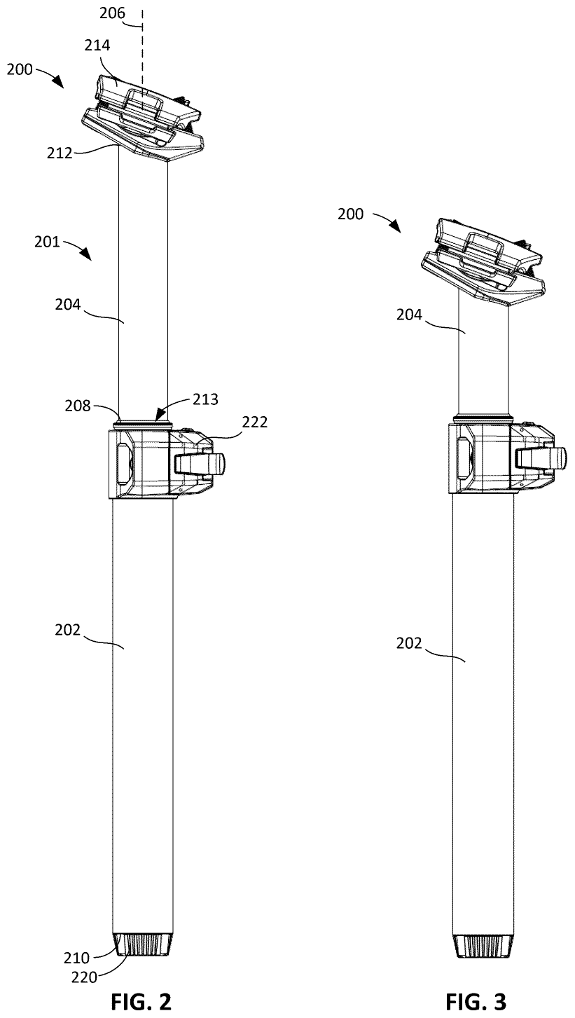

FIG. 2 is a perspective view of an example bicycle component that can include and/or incorporate an example air spring disclosed herein. In this example, the bicycle component is an example height adjustable seat post 200, also referred to as a dropper seat post or seat post assembly. The seat post 200 includes an example air spring 201. The seat post 200 can be contracted or shortened, and the air spring 201 acts to return the seat post 200 to its original or extended position. While the example air spring 201 is described in connection with the seat post 200, the example air spring 201 and/or aspects of the example air spring 201 can likewise be implemented in connection with other types of bicycle components, such as a rear shock absorber or a front suspension fork. Thus, the example air springs disclosed herein are not limited to just height adjustable seat posts.

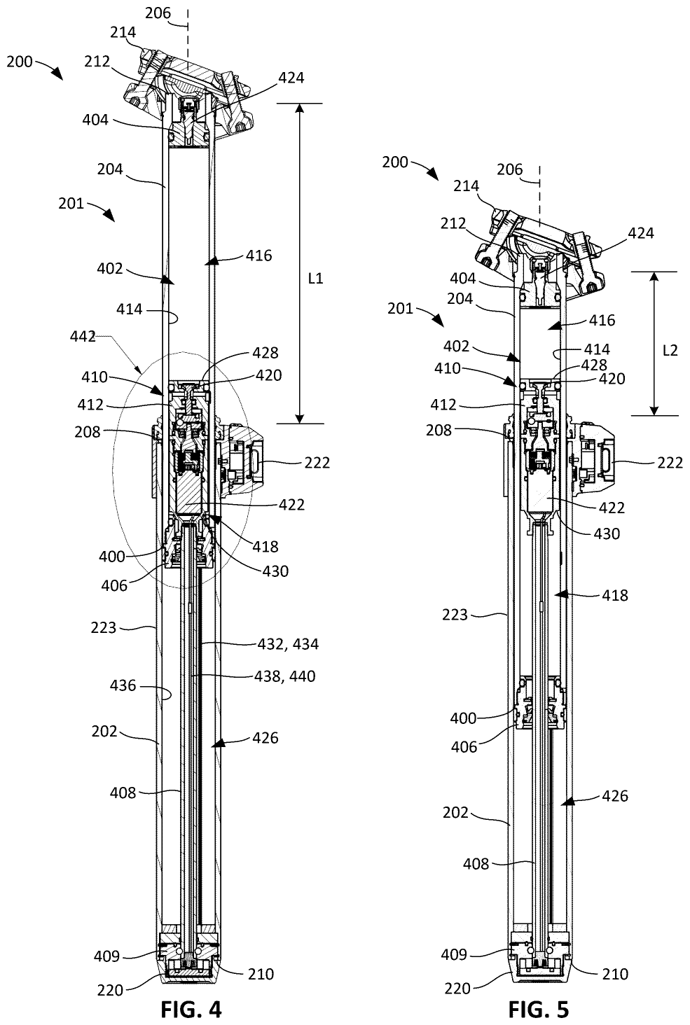

The length or height of the example seat post 200 is adjustable so that the height of the seat 110 (FIG. 1) can be raised or lowered. In the illustrated example, the seat post 200 includes a first tube 202, referred to herein as a lower tube 202, and a second tube 204, referred to herein as an upper tube 204. The upper tube 204 is part of the air spring 201. The lower and upper tubes 202, 204 may also be referred to as seat post portions or segments. As shown in FIG. 2, the lower and upper tubes 202, 204 are configured in a coaxial arrangement and aligned along an axis 206. The axis 206 corresponds to a central or longitudinal axis of the seat post 200. The lower tube 202 has a first end 208, referred to herein as an upper end 208, and a second end 210, referred to herein as a lower end 210, opposite the upper end 208. The upper tube 204 similarly has a first end 212, referred to herein as an upper end 212, and a second end 400 (shown in FIGS. 4 and 5), referred to herein as a lower end 400, opposite the upper end 212. The upper tube 204 and the lower tube 202 are configured in a telescopic arrangement. In particular, in this example, the upper tube 204 extends into an opening 213 in the upper end 208 of the lower tube 202. As such, the upper tube 204 is at least partially disposed in the lower tube 202. The upper tube 204 is slidable into and out of the opening 213 in the lower tube 202, which enables the overall height or length of the seat post 112 to change. In other examples, the lower and upper tubes 202, 204 can be configured such that the lower tube 202 extends into the lower end 500 of the upper tube 204.

In the illustrated example of FIG. 2, the seat post 200 includes a seat clamp 214 that is coupled (e.g., welded, bolted, threaded, etc.) to the upper end 212 of the upper tube 204. The seat clamp 214 is used to couple the seat 110 (FIG. 1) to the seat post 200. In some examples, the seat clamp 214 includes one or more threaded fasteners (e.g., bolts) that can be tightened to secure the seat 110 to the upper tube 204. In other examples, the seat post 200 can include other mechanisms for attaching to the seat 110. In the illustrated example, the seat post 200 includes a lower cap assembly 220 coupled to the lower end 210 of the lower tube 202.

When the seat post 200 is installed on the bicycle 100 (FIG. 1), the lower tube 202 is coupled to the frame 102 (FIG. 1). For example, the lower tube 202 can be inserted into the seat tube 114 (FIG. 1) and secured by the clamp 116 (FIG. 1). The upper tube 204 extends upward from the lower tube 202 and supports the seat 110 (FIG. 1). As disclosed in further detail herein, the air spring 201 has an internal piston and valve that enables the upper tube 204 to move (e.g., slide) downward relative to the lower tube 202 and provides rebounding force to move the upper tube 204 upward relative to the lower tube 202. This enables a rider to easily lower the height of the seat 110 or raise the height of the seat 110. The seat post 200 is adjustable between a fully extended position (also referred to as a top-out position), shown in FIG. 2, and a fully contracted position (also referred to as a bottom-out position) in which the upper tube 204 is moved into the lower tube 202 until a stop or limit is reached. The seat post 200 can also be expanded/contracted to any position between the fully extended position and the fully contracted position and maintained in place. For example, FIG. 3 shows an example in which the upper tube 204 has been partially moved into the lower tube 202. As such, the seat 110 (FIG. 1) would be lowered or closer to the ground compared to the position in FIG. 2. Therefore, the upper tube 204 and the lower tube 202 can be moved between at least a first position and a second position, where the first position may correspond to the fully extended position and the second position may correspond to the fully contracted position, or any positions therebetween.

In the illustrated example of FIG. 2, the seat post 200 includes a control module 222, which may also be referred to as a controller or control unit. In some examples, the control module 222 includes a power supply (e.g., a battery) and circuitry (e.g., processor circuitry, logic circuitry, etc.) to operate the internal valve of the air spring 201. In this example, the control module 222 is coupled to an outer surface 224 of the lower tube 202 at or near the upper end 208 of the lower tube 202. In other examples, the control module 222 can be coupled to another location on the seat post 200.

As an example operation, if a rider desires to lower the seat 110 (FIG. 1), the rider actuates a seat post actuator such as, in this example, the seat post actuation button 117 (FIG. 1). In FIG. 1, the seat post actuation button 117 is mounted on the handlebars 118 such that the rider can actuate the seat post actuation button 117 with one of their fingers (e.g., their thumb). Alternatively, the seat post actuation button 117 may be a lever or other type of user interface such a display device with a touch screen. When the seat post actuation button 117 is pressed, the seat post actuation button 117 transmits a signal (e.g., a wireless signal) to the control module 222. The control module 222 receives the signal from the seat post actuation button 117 and activates an actuator or motor to open the internal valve in a sealed pneumatic chamber in the upper tube 204, as disclosed in further detail herein. While the internal valve is open, the rider can push downward on the seat 110, which slides the upper tube 204 into the lower tube 202 (e.g., as shown in the position of FIG. 3), thereby lowering or reducing the height of the seat 110. In some examples, the rider can apply this force by sitting on the seat 110 and applying the downward force with their bottom. When the seat 110 reaches the desired height, the rider can release the seat post actuation button 117. In response, the control module 222 closes the internal valve, which maintains the upper tube 204 in place relative to the lower tube 202. When the rider desires to raise the seat 110, the rider can press the seat post actuation button 117 again. The control module 222 receives the signal and opens the internal valve. When little or no downward force is acting on the seat 110 (e.g., the rider is standing on the pedals and not resting their bottom on the seat 110), the internal pneumatic system pushes the upper tube 204 upward from the lower tube 202, thereby moving the seat 110 upward. The upper tube 202 moves upward until the fully extended position is reached. Otherwise, when the desired position is reached, the rider can release the seat post actuation button 117. When the seat post actuation button 117 is released, the internal valve closes and holds the seat post 200 in the current position. Therefore, the seat post height can be easily adjusted by the rider.

FIG. 4 is a cross-sectional view of the seat post 200 in the fully extended position corresponding to FIG. 2, and FIG. 5 is a cross-sectional view of the seat post 200 in a partially contracted position corresponding to FIG. 3.

As shown in FIGS. 4 and 5, the upper tube 204 has a lower end 400. The lower end 400 is disposed in the lower tube 202. As such, the lower and upper tubes 202, 204 overlap at an area or region of overlap. In FIG. 4, the amount of the upper tube 204 extending outward (e.g., upward) from the lower tube 202 is defined by a first length of L1, and in FIG. 5, the amount of the upper tube 204 extending outward from the lower tube 202 is defined by a second length L2, which is less than L1. As such, the overall height or length of the seat post 200 in FIG. 5 is less than the height or length of the seat post 200 in FIG. 4.

As shown in FIGS. 4 and 5, the upper tube 204 defines a sealed pressure chamber 402. The sealed pressure chamber 402 is filled with pneumatic gas such as air. The air spring 201 of the seat post 200 includes a first sealhead 404 coupled to the upper tube 204 at or near the upper end 212 to seal the upper end 212 of the upper tube 204. In this example, the first sealhead 404 is inside the upper tube 204, but in other examples can be outside the upper tube 204. In some examples, the first sealhead 404 is installed from the lower end 400. Further, the air spring 201 of the seat post 200 includes a second sealhead 406 coupled to the upper tube 204 at or near the lower end 400 to seal the lower end 400 of the upper tube 204. In this example, the second sealhead 406 is partially inside (e.g., screwed into) the upper tube 204, but in other examples can be entirely outside of the upper tube 204. The first and second sealheads 404, 406 seal the ends of the upper tube 204. As such, the sealed pressure chamber 402 is formed in the upper tube 204 between the first and second sealheads 404, 406.

In the illustrated example of FIGS. 4 and 5, the air spring 201 of the seat post 200 includes a rod 408. The rod 408 is disposed in the lower tube 202 and coupled to the lower tube 202 (e.g., near the lower end 210), such that the rod 408 is fixed relative to the lower tube 202. For example, the lower cap assembly 220 includes a mount 409 disposed in and coupled to the lower tube 202 at the lower end 210. A bottom end of the rod 408 is coupled to the mount 409. The rod 408 extends upward through the lower tube 202 and through the second sealhead 406 and into the upper tube 204. In particular, the rod 408 extends through the second sealhead 406 and into the sealed pressure chamber 402 defined in the upper tube 204. The second sealhead 406 is slidable up and down along the rod 408 as the seat post 200 expands or contracts.

In the illustrated example of FIGS. 4 and 5, the air spring 201 includes a piston assembly 410 disposed in the upper tube 204. The piston assembly 410 may also be referred to as a valve assembly or flow control assembly. The piston assembly 410 is disposed in the sealed pressure chamber 402 of the upper tube 204 and is coupled to the rod 408. As the seat post 200 expands or contracts, the piston assembly 410 moves closer to or further away from the upper and lower ends 212, 400 of the upper tube 204. The piston assembly 410 includes a piston 412 that is sealed against an inner surface 414 of the upper tube 204. The piston 412 is slidable up and down along the inner surface 414 of the upper tube 204 as the air spring 201 and the seat post 200 expand or contract. The piston assembly 410 and, in particular, the piston 412, divides the sealed pressure chamber 402 of the upper tube 204 into a first chamber 416 (between the piston 412 and the first sealhead 404) and a second chamber 418 (between the piston 412 and the second sealhead 406). The first and second chambers 416, 418 may also be referred to as upper and lower chambers, respectively, or positive and negative chambers, respectively. The first chamber 416 is bound by the piston 412, the first sealhead 404, and the upper tube 204. The second chamber 418 is bound by the piston 412, the second sealhead 406, the upper tube 204, and the rod 408. The volumes of the first and second chambers 416, 418 change as the piston 412 and the upper tube 204 move up and down relative to each other. The first and second chambers 416, 418 are filled with a fluid. In this example, the seat post 200 is based on a pneumatic platform. Therefore, the first and second chambers 416, 418 can be filled with a pressurized gas, such as pressurized air. In other examples the first and second chambers 416, 418 can be filled with another type of compressible gas (e.g., nitrogen).

In the illustrated example of FIGS. 4 and 5, the air spring 201 includes a valve 420 and a motor 422 to control the state of the valve 420. In this example, the valve 420 and the motor 422 are part of the piston assembly 410 and incorporated into and/or integrated with the piston 412. In this example, the valve 420 is a poppet valve, which includes a poppet that is moveable in a linear direction to open or close the valve 420. However, in other examples, other types of valves can be used. The valve 420 can be operated (e.g., opened or closed) to control the flow of air across the piston 412 between the first and second chambers 416, 418. In particular, the valve 420 is operable between a closed state and an open state. In the closed state, the valve 420 blocks the flow of air across the piston 412 between the first and second chambers 416, 418, which maintains the air spring 201 in its current position and, thus, maintains the lower and upper tubes 202, 204 in their current position. In the open state, the valve 420 enables the air to flow across the piston 412 between the first and second chambers 416, 418, which enables the upper tube 204 to move relative to the lower tube 202 for adjusting the height of the seat 110 (FIG. 1). While in this example the valve 420 is operated by the motor 422, in other examples the seat post 200 can include a solenoid or other type of actuator to control the valve 420. Further, while in this example the motor 422 is integrated into the piston assembly 410 in the upper tube 204, in other examples, the motor 422 can be disposed in another location. For example, the motor 422 can be coupled to the lower end 210 of the lower tube 202. Further, while in this example the piston assembly 410 includes a valve 420 for controlling the flow of fluid across the piston 410, in other examples, a valve may not be included. In some examples, the piston 410 can include a passageway with one or more shims to control or regulate the flow of fluid. In still other examples, no passageways across the piston 410 may be included.

In some examples, the air spring 201 includes a valve 424 to enable a user to add air (or another pneumatic fluid) to the sealed pressure chamber 402 or vent air from the sealed pressure chamber 402. In this example, the valve 424 is incorporated into the first sealhead 404. A user can remove the seat clamp 214 and access the valve 424 to add or remove pneumatic fluid to/from the sealed pressure chamber 402. In some examples, the valve 424 is implemented as a Schrader valve. However, in other examples, the valve 424 may be implemented as another type of valve, such as a Presta valve. In some examples, the valve 424 disposed in other locations such as on a side of the upper tube 204 near the upper end 212.

In the illustrated example of FIGS. 4 and 5, the first chamber 416 is a positive pressure chamber and the second chamber 418 is a negative pressure chamber. The first chamber 416 and the second chamber 418 are pressure sealed chambers. The lower tube 202 defines a third chamber 426 between the second sealhead 406 and the lower cap assembly 220. The third chamber 426 is considered a pressure control chamber. The volume of the third chamber 426 changes based on the actuated position. In some examples, the third chamber 426 is vented to the atmosphere and therefore contains air at atmospheric pressure. However, in other examples, the third chamber 426 is also a pressure sealed chamber (e.g., containing pressurized air or nitrogen). In such an example, the fluid (e.g., air) in the third chamber 426 may be compressed as the upper tube 204 is moved downward. This compressed fluid can provide a biasing force to return the seat post 200 to the fully extended position. In other examples, the third chamber 426 can have other mechanisms for compensating for the change in volume, such as a floating piston or a deformable bladder. The first chamber 416, the second chamber 418, and the third chamber 426 may be any number of shapes and/or sizes. For example, the first chamber 416, the second chamber 418, and the third chamber 426 may be cylindrically shaped (e.g., with outer diameters between 27 millimeters (mm) and 35 mm, respectively) and may be sized for a particular maximum post adjustment (e.g., 150 mm).

As shown in FIGS. 4 and 5, the piston 412 has a first side 428 (e.g., a top side) facing the first sealhead 404 and a second side 430 (e.g., a bottom side) opposite the first side 428 and facing the second sealhead 406. An axial surface area (as viewed along the axis 206) of the first side 428 of the piston 412 is greater than an axial surface area of the second side 430 of the piston 412. This is because a portion of the axial surface area of the second side 430 is reduced by the cross-sectional area of the rod 408. When the valve 420 is in the closed state and the seat post 200 is in the fully extended position (FIG. 4), the first chamber 416 acts as a spring and is configured to bias the upper tube 204 towards the fully extended position of the seat post 200. The first side 428 and the second side 430 of the piston 412 are sized and shaped, and the first chamber 416 and the second chamber 418 are respectively pressurized when the seat post 200 is in the fully extended position, such that the gas within the first chamber 416 supports the weight of the rider. In some examples, the seat 110 (FIG. 1) sags less than 10 mm as a result of the weight of the rider on the seat 110 when the seat post 200 is in the fully extended position. The seat post 200 operates because the axial surface area of the first side 428 of the piston 412 versus a pneumatic pressure ratio between the first chamber 416 and the second chamber 418 holds up the rider based on the force calculation. This is also dependent on the volume of the second chamber 418 at the fully extended position of the seat post 200. In the illustrated example of FIG. 4, the volume of the first chamber 416 is greater than the volume of the second chamber 418 when the seat post 112 is in the fully extended position. In some examples, the volume of the second chamber 518 may be no more than twenty percent of the volume of the first chamber 416 when the seat post 200 is in the fully extended position. In other examples, the first and second chambers 416, 418 may have a different volume ratio in the fully extended position. For example, the volume of the second chamber 418 may be no more than ten percent, five percent, or three percent of the volume of the first chamber 416 when the seat post 200 is in the fully extended position. This makes the seat post 200 act like a zero negative pressure preloaded pneumatic spring. This is the principal that holds up the rider with a feel the rider experiences as being rigid. At the fully extended position of the seat post 200, the seat 110 may move a small amount, but this movement is typically not perceivable to the rider.

As an example operation, assume the seat post 200 is in the fully extended position shown in FIG. 4 and the rider desires to lower the seat 110 (FIG. 1). The rider presses a seat post actuation button 117 (FIG. 1) on the handlebars 118 (FIG. 1), and the control module 222 activates the motor 422 to open the valve 420. When the valve 420 is open, a force can be applied downward on the seat 110 to compress the seat post 200. For example, the rider can sit (or partially sit) on the seat 110 to apply downward pressure with his/her bottom. This downward pressure forces fluid (e.g., pressurized gas) from the first chamber 416 to flow through the valve 420 and across the piston 412 and into the second chamber 418. This enables the upper tube 204 to move downward and into the lower tube 202, thereby lowering the seat 110. As the upper tube 204 is moved downward, the volume of the first chamber 416 is reduced and the volume of the second chamber 418 is increased. The rider can move (e.g., lower) the seat 110 to any position between the fully extended position and a fully contracted position. FIG. 5 shows the seat post 200 as in an intermediate position between the fully extended position and the fully contracted position.

When the seat 110 is at a desired position, such as the position in FIG. 5, the rider can release the seat post actuation button 117 (FIG. 1). The control module 222 activates the motor 422 to close the valve 420. When the valve 420 is closed, the fluid (e.g., pressurized gas) is prevented from flowing across the piston assembly 410 between the first chamber 416 and the second chamber 418. This limits or prevents further relative movement of the upper tube 204 relative to the lower tube 202. When the valve 420 is closed, the balance of forces in the system is such that the axial pressure force acting on the first side 428 of the piston 412 is approximately equal to the axial pressure force acting on the second side 430 of the piston 412. Using a compressible fluid such as air enables the pressure chamber to act as a compression spring when a downward force is applied on the upper tube 204. Therefore, when the rider sits on the seat 110, the seat post 200 can support the weight of the rider. In some examples, when the seat post 200 is in an intermediate position (between the fully extended position and the fully contracted position), the seat 110 may sag a small amount (e.g., 40 mm or less) as a result of the weight of the rider. The seat post 200 can be maintained at any position between the fully extended position and the fully contracted position. If the seat post 200 is moved to the fully contracted position, the seat clamp 214 contacts the upper end 208 of the lower tube 202 and/or the second sealhead 406 contacts the lower cap assembly 220. This provides a hard stop to prevent further movement. When the seat post 200 is in the fully contracted position, the seat 110 may not sag due to this hard stop.

When it is desired to raise the seat post 200 back to the fully extended position, the rider presses on the seat post actuation button 117 (FIG. 1), and the control module 222 activates the motor 422 to open the valve 420. With no external downward force acting on the seat 110 (FIG. 1), the pressure in the first chamber 416 the upper tube 204 causes the upper tube 204 to move upward relative to the lower tube 202 back to the fully extended position. This is because the axial surface area of the first side 428 of the piston 412 is greater than the axial surface area on the second side 430 of the piston 412. As such, the force of the pressure in the first chamber 416 acting on the first side 428 of the piston 412 is larger than the force from the pressure in the second chamber 418 acting on the second side 430 of the piston 412. As a result, the upper tube 204 is forced upward to the fully extended position. As the upper tube 204 moves upward, fluid flows across the valve 420 from the second chamber 418 to the first chamber 416. Therefore, the axial pressure force imbalance biases the seat post 200 towards the fully extended position. As such, the air spring 201 acts to automatically expand the seat post 200 back to the fully extended position shown in FIG. 4. In particular, the upper tube 204 moves upward relative to the lower tube 202 until the top of the second sealhead 406 engages the second side 430 of the piston 412. This forms a limit or stop that defines the fully extended (top-out) position. When the seat post 200 in the fully extended position, the rider can release the seat post actuation button 117, which activates the motor 422 to close the valve and thereby maintain the seat post 112 in the fully extended position. Therefore, the pressurized gas in the first chamber 416 biases the upper and lower tubes 204, 202 away from each other, and the pressurized gas in the second chamber 418 biases the upper and lower tubes 204, 202 toward each other.

As disclosed above, the control module 222 can include processor circuitry that is configured to control and operate the motor 422 to open and close the valve 420. The control module 222 is located on the outer surface 223 of the lower tube 202, at or near the upper end 208 of the lower tube 202, while the motor 422 is located in the piston assembly 410 in the sealed pressure chamber 402 of the upper tube 204. The seat post 200 can include one or more wires and/or electrical connections to form an electrical path between the control module 222 and the motor 422. This enables power and/or command signals to be transferred between the control module 222 and the motor 422. For example, as shown in FIG. 4, the seat post 200 includes first and second outer tube wires 432, 434 disposed in the lower tube 202. In some examples, the first and second outer tube wires 432, 434 are positive and negative wires. The first and second outer tube wires 432, 434 are electrically coupled to the control module 222. The first and second outer tube wires 432, 434 extend through the lower tube 202 to the lower cap assembly 220. In some examples, the first and second outer tube wires 432, 434 are disposed along an inner surface 436 of the lower tube 202 (e.g., in one or more channels disposed along the inner surface 436).

In the illustrated example of FIG. 4, the seat post 200 also includes first and second inner tube wires 438, 440. The first and second inner tube wires 438, 440 are disposed in the rod 408 and extend between the lower cap assembly 220 and the motor 422. The lower cap assembly 220 includes one or more electrical connectors or wire bridging to electrically couple the outer tube wires 432, 434 and the respective inner tube wires 438, 440. The outer and inner tube wires 432, 434, 438, 440 can be soldered or crimped to the electrical connectors in the lower cap assembly 220. Therefore, the outer tube wires 432, 434, the inner tube wires 438, 440, and the electrical connectors form an electrical path between the control module 222 and the motor 422. As such, positive and negative electrical connections are formed between the control module 222 and the motor 422. The control module 222 can activate the motor 422 by applying power through the electrical connections. While in this example the state of the seat post 200 is changed electronically by the control module 222, in other examples, the seat post 200 can be configured to be changed states by a hydraulic line or a mechanical cable or linkage.

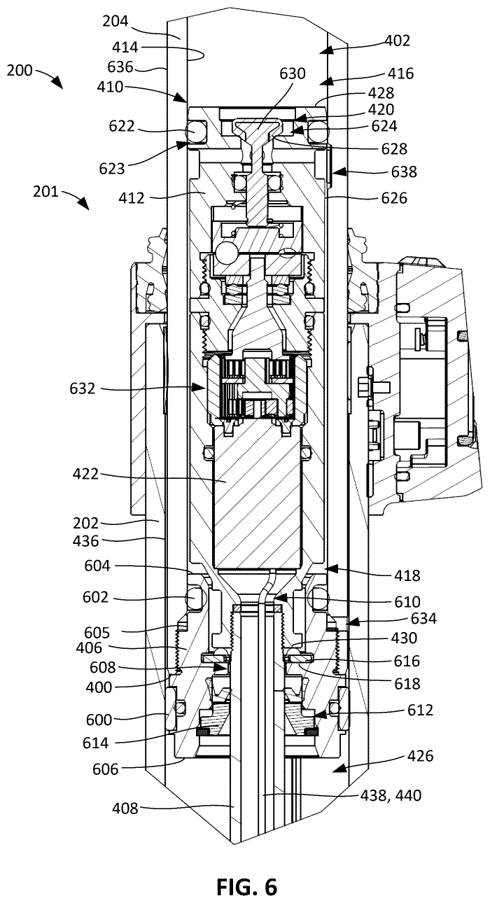

FIG. 6 is an enlarged view of the callout 442 of FIG. 4. As shown in FIG. 6, the second sealhead 406 is threadably coupled to the lower end 400 of the upper tube 204 to seal the lower end of the sealed pressure chamber 402. The seat post 200 includes a lower bushing 600 in a groove in the second sealhead 406 and is slidably engaged with the inner surface 436 of the lower tube 202. As the upper tube 204 telescopes relative to the lower tube 202, the lower bushing 600 enables the tubes 202, 204 to slide smoothly relative to each other as well as radially supports the upper tube 204.

In the illustrated example, a seal 602 (e.g., an o-ring) is coupled to the second sealhead 406. The seal 602 is in sealing contact with the inner surface 414 and thereby forms a fluid tight seal between the second sealhead 406 and the inner surface 414 of the upper tube 204. In the illustrated example, the seal 602 is disposed in a seal gland 603 formed in an outer surface 605 of the second sealhead 406. As such, the seal 602 is coupled to and moves with the second sealhead 406 (e.g., during assembly or disassembly). In other examples, the seal 602 can be coupled to the second sealhead 406 via other chemical or mechanical techniques (e.g., threaded fasteners, adhesives, etc.).

The second sealhead 406 has a first end 604, a second end 606 opposite the first end 604, and a channel 608 extending through the second sealhead 406 between the first end 604 and the second end 606. The first end 604 faces and/or is exposed to fluid in the second chamber 418, and the second end 606 faces and/or is exposed to fluid in the third chamber 426. The rod 408 extends through the channel 608. The second sealhead 406 has a first bore 610 extending into the first end 604 and a second bore 612 extending into the second end 606 that form a portion of the channel 608. In the illustrated example, the seat post 200 includes a shaft seal 614 disposed in the second bore 612. The shaft seal 614 forms a pressure tight seal between the second sealhead 406 and the rod 408 to prevent fluid leakage through the second sealhead 406. The shaft seal 614 also enables the second sealhead 406 to slide smoothly up and down along the shaft 508 as the seat post 112 expands and contracts.

In the illustrated example, the air spring 201 includes a bumper 616 (which may be referred to as a top-out bumper) coupled to the second sealhead 406. When the seat post 200 or the air spring 201 is in the fully extended position, as shown in FIG. 6, the second side 430 of the piston 412 is engaged with or contacting the bumper 616. The bumper 616 reduces shock loads when the seat post 200 from a top-out actuation. In some examples, the bumper 616 is constructed of a compliant or elastic material, such as rubber. For example, the bumper 616 may be constructed of a softer rubber or a harder rubber in the range of 40 A to 90 A on the Shore A scale, but in other examples could be harder or softer. As another example, the bumper 616 may be constructed of a viscoelastic material, such as urethane or buna-nitrile. In the illustrated example, the bumper 616 is disposed in the first bore 610 and along a shoulder 618 of the first bore 610. In the illustrated example, the bumper 616 is disposed in a gland or groove to retain in the bumper 616 in position. Additionally or alternatively, the bumper 616 can be coupled to the second sealhead 406 via other techniques (e.g., a threaded fastener, an adhesive, friction fit).

The piston assembly 410 includes the piston 412. The piston 412 can be constructed of one or multiple body portions that are coupled together. In some examples, the piston 412 is constructed of metal and/or a plastic polymer. In the illustrated example, the piston 412 and the rod 408 are threadeably coupled. In other examples the piston 412 and the rod 408 can be coupled via other attachment techniques (e.g., welding, fasteners, etc.).

In the illustrated example, the piston assembly 410 of the air spring 201 includes a piston seal 622 (e.g., an o-ring) that is coupled to the piston 412 and in sealing contact with the inner surface 414 of the upper tube 204. In this example, the piston seal 622 is disposed in a seal gland 623 formed in an outer side surface 626 of the piston 412. In other examples, the piston seal 622 can be coupled to the piston 412 via other techniques. The piston seal 622 is engaged with and seals against the inner surface 414 to prevent fluid leakage between the inner surface 414 of the upper tube 204 and the outer side surface 626 of the piston 412. As such, the piston seal 622 divides the sealed pressure chamber 402 into the first chamber 416 (the positive chamber) between the piston seal 622 the first sealhead 404 (FIG. 4) and the second chamber 418 (the negative chamber) tween the piston seal 622 and the second sealhead 406.

In the illustrated example, the piston 412 defines a fluid passageway 624 extending between the first side 428 of the piston 412 and the outer side surface 626 of the piston 412. As such, the fluid passageway 624 fluidly connects the first chamber 416 and the second chamber 418. A portion of the fluid passageway 624 forms a sealing surface or seat 628. In the illustrated example, the piston assembly 410 includes a flow control member 630 (e.g., a poppet, a plug). The flow control member 630 is slidably disposed in the fluid passageway 624. In this example, the flow control member 630 is moveable in a linear direction between a closed position and an open position. In the closed position, which is shown in FIG. 6, the flow control member 630 is engaged with the seat 628 and blocks fluid flow through the fluid passageway 624. As such, fluid is prevented from flowing across the piston 412 between the first and second chambers 416, 418. In the open position, the flow control member 630 is spaced from the seat 628 and therefore allows fluid flow through the fluid passageway 624 and across the piston 412 between the first and second chambers 416, 418. The fluid passageway 624 and the flow control member 630 form the valve 420. As such, the valve 420 is disposed in and/or formed at least partially by the piston 412. The valve 420 is operable between the closed state to block fluid flow across the piston 412 and the open state to allow fluid flow across the piston 412.

In the illustrated example, the motor 422 is disposed in the piston 412. As shown in FIG. 6, the inner wires 438, 440 extend through the rod 408 and into the piston 412 and the electrically connected to the motor 422. The motor 422, when activated, moves the flow control member 630 between the closed and open positions. In the illustrated example, the piston assembly 410 includes a gear system 632 in the piston 412, operably coupled between the motor 422 and the flow control member 630. The gear system 632 transfers power and/or movement from the motor 422 to the flow control member 630. In some examples, the gear system 632 includes one or more gear arrangements (e.g., a planetary gear system) to provide speed reduction between the output shaft and the flow control member 630. In some examples, the motor 422 has a rotatable output shaft, while the flow control member 630 is moveable in a linear direction. Therefore, the gear system 632 is used to convert rotational motion of the output shaft to linear movement of the flow control member 630. In other examples, the valve 420 can be configured as a rotary valve. In such an example, the flow control member 630 would rotate between the closed position and the open position. In other examples, the motor 422 can be implemented as a linear-type motor or solenoid that has a linear moving output shaft.

In some instances, the seat post 200 and the air spring 201 may need to be disassembled for maintenance and/or repair. To disassemble the air spring 201, for example, a person typically depressurizes the sealed pressure chamber 402 by opening the valve 424 (FIG. 4). Then, the person can remove (e.g., unscrew) the second sealhead 406 from the lower end 400 of the upper tube 204, and slide the piston assembly 410 and the rod 408 outward from the lower end 400 of the upper tube 204. However, a person may forget to depressurize the sealed pressure chamber 402 before removing the second sealhead 406. As a result, the high pressure in the sealed pressure chamber 402 can cause one or more parts to be ejected from upper tube 204. The example air spring 201 disclosed herein provides one or more depressurization features that automatically vent and/or otherwise allow the sealed pressure chamber 402 to be depressurized when the second sealhead 406 is being disconnected from the upper tube 204. Therefore, prior to the second sealhead 406 being fully disconnected from the upper tube 204, the chamber 502 is depressurized. This reduces or eliminates the risk of parts being ejected from the air spring 201.

In the illustrated example of FIG. 6, the upper tube 204 has a vent port 634 (e.g., an opening, a channel) extending between the inner surface 414 and an outer surface 636 of the upper tube 204. In the illustrated example, the vent port 634 is located near the lower end 400 of the upper tube 204. As disclosed in further detail herein, as the second sealhead 406 is being unscrewed from the upper tube 204, the vent port 634 allows pressurized air in the second chamber 418 to evacuate to the atmosphere before the second sealhead 406 is completely disconnected from the upper tube 204. Further, as shown in FIG. 6, the inner surface 414 of the upper tube 204 has a recess, which, in this example, is implemented as a dimple 638. When the piston seal 622 moves into or past the dimple 638, the dimple 638 allows fluid communication between the first and second chambers 416, 418, which allows pressurized air from the first chamber 416 to be vented to the second chamber 418 and out through the vent port 634. In other examples, the recess can be implemented by another circumferential discontinuity or feature on the inner surface 414, such as an annular groove.

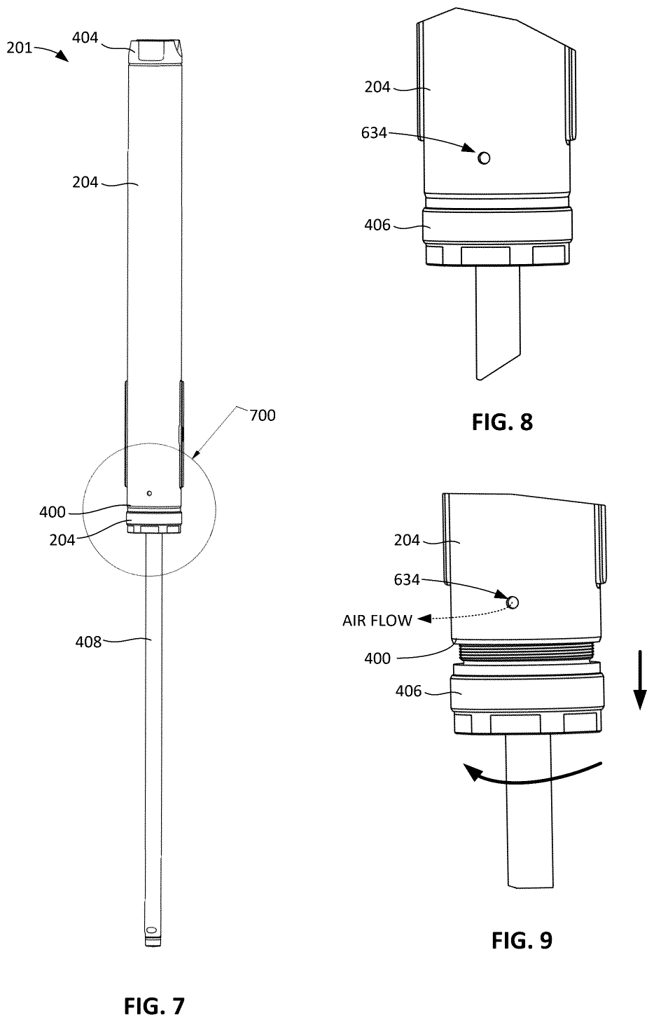

FIG. 7 is a side view of the air spring 201 as removed from the lower tube 202 (FIG. 2). The air spring 201 includes the upper tube 204, the first sealhead 404 (FIG. 4), the second sealhead 406, the piston assembly 410 (FIG. 4) with the piston 412 (FIG. 4) in the upper tube 204, and the rod 408. The rod 408 extends through the second sealhead 406 and into the sealed pressure chamber 402 (FIG. 4) in the upper tube 204 and is coupled to the piston 412. In the illustrated example, the air spring 201 is in an extended state in which the rod 408 is fully extended from the lower end 400 of the upper tube 204. The rod 408 can be pushed into the upper tube 204, which moves the piston 412 upward in the upper tube 204 and compresses the fluid in the first chamber 416 (FIG. 4). When the force on the rod 408 is released, the pressure differential across the piston 412 moves the piston 412 downward and therefore pushes the rod 408 back outward to the fully extended state shown in FIG. 7. The piston 412 can also be held at an intermediary position by operating the valve 420 (FIG. 4), as disclosed above.

FIG. 8 is an enlarged view of the callout 700 of FIG. 7. The vent port 634 is shown in FIG. 8. In this example the vent port 634 is a circular opening or hole, but in other examples can be shaped differently. To disassemble the air spring 201 and/or otherwise access the inside of the upper tube 204, the second sealhead 406 can be unscrewed from the upper tube 204. As shown in FIG. 9, as the second sealhead 406 is unscrewed from the upper tube 204, the second sealhead 406 moves outward from the lower end 400 of the upper tube 204. Further, air in the sealed pressure chamber 402 (FIG. 4) is vented out of the vent port 634, which depressurizes the sealed pressure chamber 402 before the second sealhead 406 is completely disconnected from the upper tube 204.

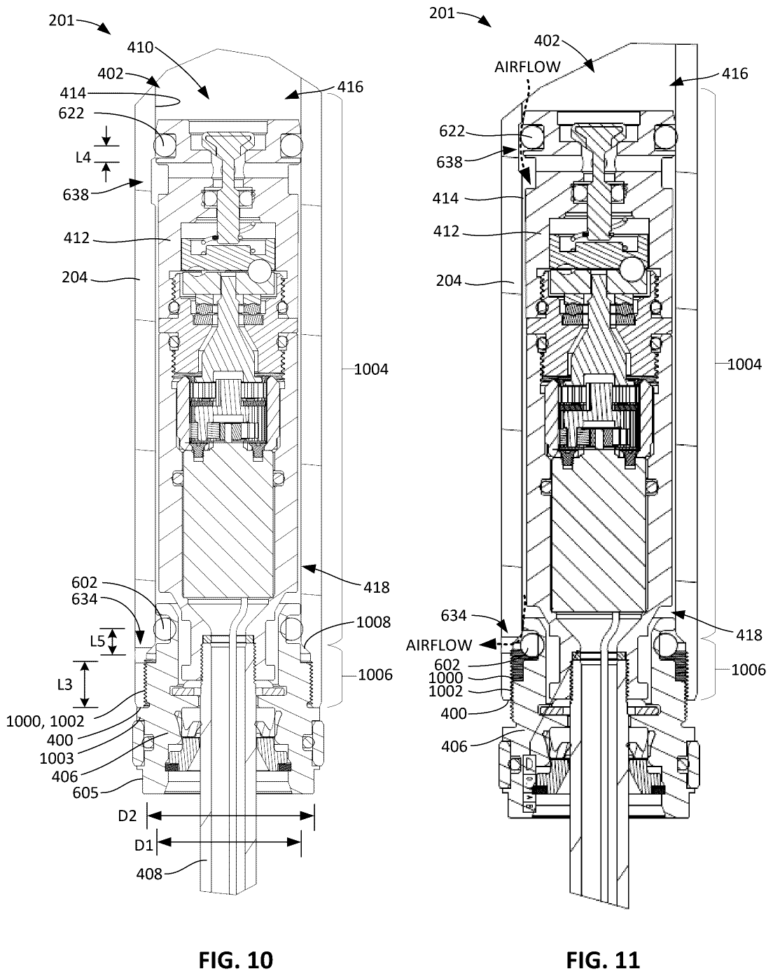

FIG. 10 is a cross-sectional view showing the lower portion of the upper tube 204 with the second sealhead 406 fully coupled or attached to the upper tube 204. In this example, the second sealhead 406 and the upper tube 204 are coupled by a threaded connection. In particular, the inner surface 414 of the upper tube 204 has internal threads 1000 near the lower end 400. The outer surface 605 of the second sealhead 406 has external threads 1002 that are threaded or meshed with the internal threads 1000 of the upper tube 204 to form the threaded connection.

The second sealhead 406 and the upper tube 204 are coupled along an axial interface locking length L3. In this example, the axial interface locking length L3 is defined by a threaded overlap between the upper tube 204 and the second sealhead 406. The axial interface locking length L3 also represents the axial distance the second sealhead 406 can be moved (e.g., screwed or unscrewed) relative to the upper tube 204 between a fully coupled position and a decoupled/separated position. The fully coupled position, which is shown in FIG. 10, is defined as the position in which the threads 1000, 1002 are fully (e.g., maximally) engaged along the axial interface locking length L3. In some examples, the fully coupled position is defined by a stop feature. For example, as shown in FIG. 10, the second sealhead 406 has a flange 1003 that is engaged with the lower end 400 of the upper tube 204. This prevents the second sealhead 406 from being screwed further into the upper tube 204. In the fully coupled position shown in FIG. 10, the internal and external threads 1000, 1002 are completely overlapping or fully meshed. To decouple or remove the second sealhead 406, the second sealhead 406 can be unscrewed from the lower end 400 of the upper tube 204. However, even while the second sealhead 406 is being unscrewed, as long as there are some threads overlapping, the second sealhead 406 is still axially coupled to the upper tube 204. The second sealhead 406 becomes fully decoupled or separated from the upper tube 204 when the top thread (in the orientation of FIG. 10) on the second sealhead 406 passes the bottom thread on the upper tube 204, at which point there is no axial coupling and the second sealhead 406 can freely move in the axial direction away from the lower end 400 of the upper tube 204.

As shown in FIG. 10, the upper tube 204 has a first section 1004 with a first inner diameter D1 and a second section 1006 with a second inner diameter D2 adjacent the lower end 400. The second inner diameter D2 is larger than the first inner diameter D1. In the illustrated example, the inner surface 414 of the upper tube 204 has a lead-in 1008, which is an angled or tapered surface between the first section 1004 and the second section 1006. The lead-in 1008 assists in installing the seal 602 and the piston seal 622 during assembly (e.g., by gradually radially compressing the seals 602, 622), as well as helps to avoid seal damage during installation/disassembly.

In the illustrated example, the piston 412 and the rod 408 are in a top-out position in which the piston 412 is engaged, directly or indirectly, with the second sealhead 406. During normal operation, the piston 412 and the rod 408 are movable in the upper tube 204 between the top-out position and a bottom-out position (e.g., when the piston assembly 410 engages the first sealhead 404 (FIG. 4)). During normal operation, the piston seal 622 remains in full circumferential sealing contact with the inner surface 414 of the upper tube 204 along the first section 1004 having the first inner diameter D1. As such, the piston seal 622 fluidly separates the first and second chambers 416, 418. In the illustrated example, the dimple 638 is located closer to the lower end 400 of the upper tube 204 than the piston seal 622. When the piston 412 is in the top-out position, as shown in FIG. 10, the piston seal 622 is axially spaced from the dimple 638 by a dimple seal gap LA. Therefore, during normal operation, the piston seal 622 always stays above and/or otherwise does not overlap or cross the dimple 638.

As shown in FIG. 10, the vent port 634 is located along the second section 1006 having the second inner diameter D2. Further, the vent port 634 is located below the seal 602 in the orientation of FIG. 10, i.e., the vent port 634 is closer to the lower end 400 than the seal 602. When the second sealhead 406 is fully coupled along the axial interface locking length L3, as shown in FIG. 10, the seal 602 is axially spaced from the second section 1006 by a port seal gap L5. In this example, the seal 602 is also axially spaced from the vent port 634 by the port seal gap L5. Therefore, in this example, the vent port 634 is at the same axial location as the transition to the second section 1004. The port seal gap L5 represents the axial distance that the second sealhead 406 needs to move before the seal 602 loses sealing contact and venting occurs. However, when the second sealhead 406 is fully coupled to the upper tube 204, as shown in FIG. 10, the seal 602 remains in full circumferential sealing contact with the inner surface 414 of the upper section of the upper tube 204. This forms a fluid tight seal that keeps the pressure in the sealed pressure chamber 402.

To disassemble the air spring 201, a person may unscrew the second sealhead 406 from the lower end 400 of the upper tube 204. FIG. 11 shows the second sealhead 406 in a partially unscrewed state. In particular, the lower seal head 406 has been partially unscrewed but is still axially coupled to the upper tube 204 by a portion of the threads 1000, 1002. As the second sealhead 406 is unscrewed, the second sealhead 406 moves outward or away from the lower end 400 of the upper tube 204. As shown in FIG. 11, the seal 602 has moved downward a greater distance than the port seal gap L5 and, thus, has moved into the second section 1006 with the larger, second inner diameter D2 and/to otherwise at least partially overlaps with the vent port 634. As a result, the seal 602 loses full circumferential sealing contact with the inner surface 414 of the upper tube 204. As shown by the airflow line, air in the second chamber 418 can bypass the seal 602 and flow out of the vent port 634 to the atmosphere, thereby depressurizing and/or otherwise equalizing the second chamber 418 with atmospheric pressure.

Further, as the second sealhead 406 is being unscrewed and therefore moved outward from the upper tube 204, the pressure difference in the first and second chambers 416, 418 causes the piston 412 to move downward and remain biased against (e.g., in direct or indirect contact) the second sealhead 406. As such, as shown in FIG. 11, the piston 412 has moved downward and the piston seal 622 at least partially overlaps with the dimple 638. As a result, the piston seal 622 loses full circumferential sealing contact with the inner surface 414 of the upper tube 204. Therefore, as shown by the airflow line, air in the first chamber 416 can bypass the piston seal 622 and flow into the second chamber 418, which is vented to the atmosphere via the vent port 634. Thus, before the second sealhead 406 is entirely decoupled or separated from the upper tube 204, the entire sealed pressure chamber 402 is vented to atmosphere and depressurized.

As can be appreciated from FIGS. 10 and 11, the dimple seal gap L4 and the port seal gap L5 are less than the axial interface locking length L3. This enables the piston seal 622 and the seal 602 to reach positions where they lose sealing contact with the inner surface 414 to enable at least a portion of the sealed pressure chamber 402 to be equalized with atmospheric air before the second sealhead 406 is fully decoupled (i.e., axially separated) from the upper tube 204. Therefore, anytime the second sealhead 406 is unscrewed from the upper tube 204, the sealed pressure chamber 402 is automatically depressurized before the second sealhead 406 becomes fully decoupled from the upper tube 204. In some examples, the dimple seal gap L4 and the port seal gap L5 are the same, and may be about 1 mm-5 mm (e.g., +0.2 mm), but in other examples can be larger or smaller.

In the example of FIGS. 10 and 11, the vent port 634 is located at the same axial location as the transition to the second section 1004. However, in other examples, the vent port 634 can be located further from the transition, such as further downward toward the lower end 400. In such an example, when the seal 602 moves downward a distance of at least the port seal gap L5, the seal 602 still loses sealing contact and air in the sealed pressure chamber 402 flows past the seal 602 and through the vent port 634. Therefore, the spacing between the seal 602 and the vent port 634 may be greater than the spacing between the seal 602 and the location where the seal 602 loses sealing contact. In other examples, the vent port 634 may be located along the first section 1004 of the upper tube 204. In such an example, when the seal 602 at least partially overlaps with the vent port 634, the seal 602 loses sealing contact and venting occurs. Therefore, in some examples, the venting may occur before the seal 602 reaches the second section 1006.

While in the illustrated example the air spring 201 includes the valve 420 for controlling fluid flow across the piston 412, in other examples, the air spring 201 may not include a valve. In other words, the air spring 201 can include a piston without a valve.

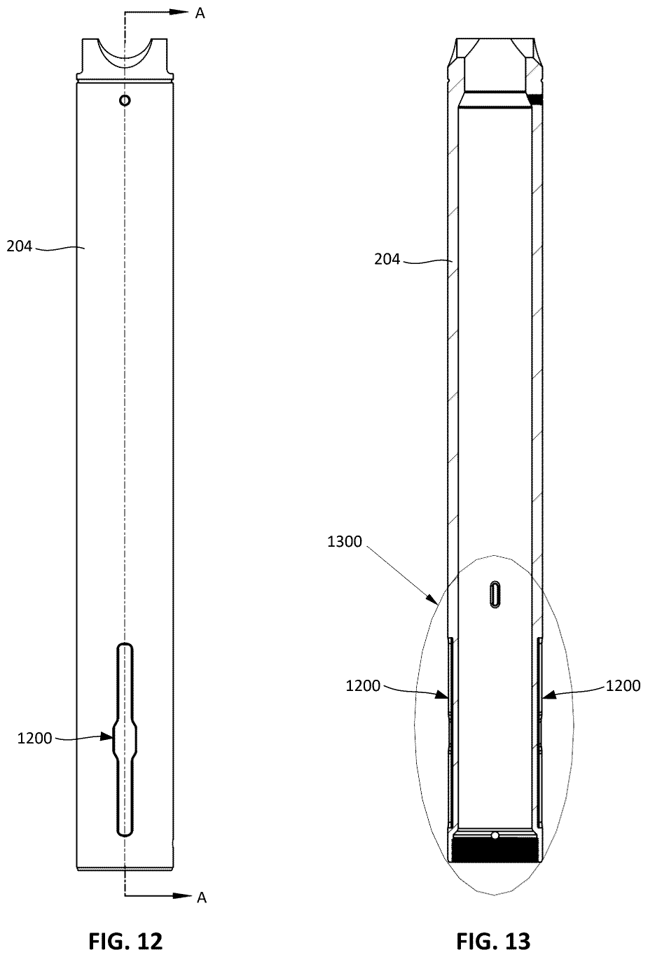

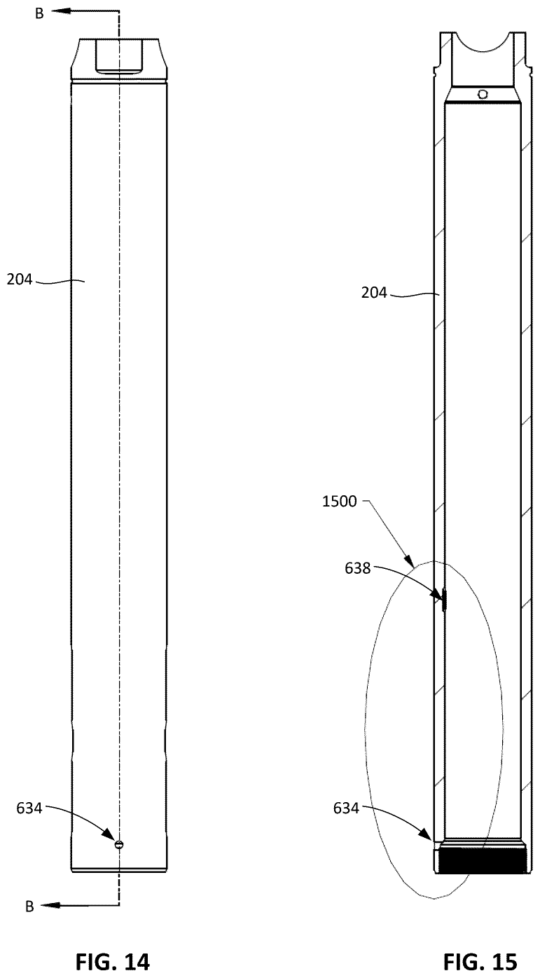

FIG. 12 is a side view of the upper tube 204. FIG. 13 is a cross-sectional view of the upper tube 204 taken along line A-A of FIG. 12. As shown in FIGS. 12 and 13, the outer surface of the upper tube 204 may have one or more grooves 1200 that mate with features on the inside of the lower tube 202 to keep the lower and upper tubes 202, 204 from rotating relative to each other. FIG. 14 is a side view of the upper tube 204 shown at 90° to the orientation in FIG. 12. FIG. 15 is a cross-sectional view of the upper tube 204 taken along line B-B of FIG. 14 and through the vent port 634 and the dimple 638.

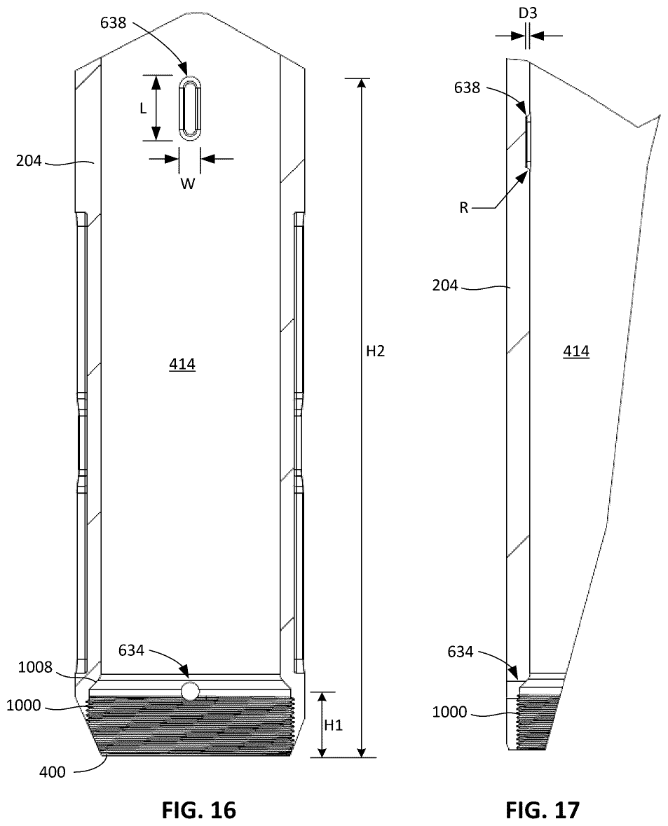

FIG. 16 is an enlarged view of the callout 1300 of FIG. 13 showing the vent port 634 and the dimple 638. FIG. 17 is an enlarged view of the callout 1500 of FIG. 15 showing the vent port 634 and the dimple 638. In the illustrated example, the upper tube 204 has one vent port 634 and one dimple 638. However, in other examples, the upper tube 204 can include multiple vent ports and/or multiple dimples. For example, the upper tube 204 can include multiple vent ports (e.g., two, three, four, etc.), at the same axial location, that are spaced circumferentially around the upper tube 204. Additionally or alternatively, the upper tube 204 can include multiple dimples, at the same axial location, that are spaced circumferentially around the inner surface 414 of the upper tube 204. In some examples, the upper tube 204 is constructed of aluminum alloy, but in other examples can be constructed of other materials such as steel alloy, titanium, composite or carbon fiber. In some examples, the upper tube 204 may have an outer diameter 10 mm to 75 mm, but in other examples can be larger or smaller depending on the desired use/application for the air spring 201. In some examples, the vent port 634 can be drilled through the wall of the upper tube 204, for example. In some examples, the dimple 638 can be formed with force from a dimple shaped forming tool, or the dimple 638 may be machined with a geared 90-degree surface machining tool.

As disclosed above, the upper tube 204 has internal threads 1000, which form the coupling interface between the upper tube 204 and the second sealhead 406 (FIG. 10). In other examples, the coupling interface can be formed by other structures such as circlip plus grooves, a circumferential clamp, or a similar interlocking feature to attach the second sealhead 406.

As shown in FIGS. 16 and 17, the center of the vent port 634 is located at a first height H1 from the lower end 400. The vent port 634 can be located on or above the internal threads 1000 (i.e., the coupling interface). For example, in the illustrated example, a portion the vent port 634 overlaps with a portion of the internal threads 1000. However, in other examples, the vent port 634 can be located higher on the upper tube 204 and not overlap at all with the internal threads 1000. In some examples, the vent port 634 has a diameter that is large enough to ensure rapid depressurization, but is not overly large so as to avoid seal extrusion damage of the seal 602 squeezing into the vent port 634. The vent port 634 may also be relatively small to promote a shorter sealhead 406, which results in a shorter overall seat post. For example, the vent port 634 may have a diameter of between 0.5 mm and 5 mm. However, in other examples, the vent port 634 can be larger or smaller. In the illustrated example, the vent port 634 is at or near the height of the lead-in 1008, but in other examples can be spaced further down from the lead-in.

As shown in FIG. 16, the dimple 638 is located on the inner surface 414 of the upper tube 204 at a height H2 from the lower end 400, which is greater than the first height H1. In the illustrated example, the dimple 638 is stadium-shaped and oriented in an axial direction. However, in other examples, the dimple 638 can have other shapes, such as circular, rectangular, oval, etc. and/or be oriented differently. In some examples, the dimple 638 has length L of 5 mm and a width W of 1.5 mm, but in other examples these dimensions can be larger or smaller. In some examples, the dimple has a length L that is greater than a thickness of the piston seal 622 (as depicted more clearly in FIGS. 10 and 11). As such, when the piston seal 622 overlaps or passes the dimple 638, the piston seal 622 loses sealing contact with the inner surface 414 of the upper tube 204. As shown in FIG. 17, the dimple 638 has a depth D3 that is less than the thickness of the upper tube 204. In some examples, the dimple 638 has a depth D3 of about 0.3 mm to about 2 mm, but can be deeper or shallower in other examples. In some examples, the edges of the dimple 638 are at least partially rounded, curved, or chamfered to reduce damage (e.g., tearing or cutting) to the piston seal 622. In some examples, the edges of the dimple 638 have a radii R of about 0.5 mm radii, but in other examples can be larger or smaller.

While in the examples described above the seal 602 is coupled to the second sealhead 406 and the vent port 634 is formed in the upper tube 204, the seal 602 and the vent port 634 could be reversed. For example, the seal 602 could instead be coupled to (e.g. disposed in a gland on) the inner surface 414 of the upper tube 204 while the second sealhead 406 has a vent port or recess to enable air to bypass the seal 602 and flow out of the second end 400 when the second sealhead 406 is being removed from the upper tube 204. Similarly, the piston seal 622 could instead be coupled to (e.g., disposed in a gland on) the inner surface 414 of the upper tube 204 while the piston 412 has a recess (e.g., a dimple, an annular groove) to enable air to bypass the piston seal 622 when the piston 412 is moved downward.

Example systems, apparatus, method, and articles of manufacture for bicycles (and/or other vehicles) are disclosed herein. Examples and combinations of examples disclosed herein include the following:

Example 1 is an air spring for a bicycle component, the air spring comprising: a tube having a first end and a second end opposite the first end; a first sealhead coupled to the tube at or near the first end; a second sealhead coupled to the tube at or near the second end such that a sealed pressure chamber is formed in the tube between the first and second sealheads, and wherein the second sealhead and the tube are coupled along an axial interface locking length; and a seal coupled to the second sealhead and in sealing contact with an inner surface of the tube, wherein the tube has a vent port extending between an inner surface and an outer surface of the tube, and wherein the seal is spaced from the vent port by a port seal gap that is less than the axial interface locking length such that as the second sealhead is being decoupled from the tube, the seal loses sealing contact with the inner surface to enable at least a portion of the sealed pressure chamber to be equalized with atmospheric air before the second sealhead is fully decoupled from the tube.

Example 2 includes the air spring of Example 1, wherein the second sealhead and the tube are coupled by a threaded connection, and wherein the axial interface locking length is defined by a threaded overlap between the second sealhead and the tube.

Example 3 includes the air spring of claim 2, wherein the inner surface of the tube has internal threads and an outer surface of the second sealhead has external threads that are meshed with the internal threads to form the threaded connection.

Example 4 includes the air spring of any of Examples 1-3, further including: a piston in the sealed pressure chamber; and a rod coupled to the piston.

Example 5 includes the air spring of Example 4, wherein the rod extends through a channel in the second sealhead.

Example 6 includes the air spring of Examples 4 or 5, further including a piston seal coupled to the piston, the piston seal in sealing contact with the inner surface of the tube such that the piston seal divides the sealed pressure chamber into a first chamber between the piston seal and the first sealhead and a second chamber between the piston seal and the second sealhead.

Example 7 includes the air spring of Example 6, wherein the inner surface of the tube has a dimple, and wherein the piston seal is spaced from the dimple by a dimple seal gap.

Example 8 includes the air spring of Example 7, wherein the dimple seal gap is less than the axial interface locking length such that as the second sealhead is being removed from the tube, the piston seal at least partially overlaps with the dimple and loses sealing contact with the inner surface to enable airflow between the first and second chambers before the second sealhead is fully decoupled from the tube.

Example 9 includes the air spring of Example 8, wherein the dimple is closer to the second end of the tube than the piston seal.

Example 10 includes the air spring of any of Examples 7-9, wherein the vent port is a first distance from the second end and the dimple is a second distance from the second end, the second distance being greater than the first distance.

Example 11 includes the air spring of any of Examples 1-10, further including a valve coupled to the first sealhead to enable a user to add air to the pressurized sealed chamber or vent air from the pressurized sealed chamber.

Example 12 includes the air spring of any of Examples 1-11, further including a seat clamp coupled to the first end of the tube, the seat clamp to couple to a seat of the bicycle.

Example 13 includes the air spring of any of Examples 1-12, wherein the sealed pressure chamber is filled with pressurized air.

Example 14 includes the air spring of any of Examples 1-13, wherein the seal is disposed in a seal gland formed in an outer surface of the second sealhead.

Example 15 is an air spring for a bicycle component, the air spring comprising: a tube having a first end and a second end opposite the first end, a first section of the tube having a first inner diameter, a second section of the tube adjacent the second end having a second inner diameter that is larger than first inner diameter; a first sealhead coupled to the tube at or near the first end; a second sealhead coupled to the tube at or near the second end such that a sealed pressure chamber is formed in the tube between the first and second sealheads, the second sealhead and the tube coupled along an axial interface locking length; and a seal coupled to the second sealhead and in sealing contact with an inner surface of the tube along the first section, wherein the tube has a vent port located along the second section, and wherein the seal is axially spaced from the second section by a port seal gap that is less than the axial interface locking length such that as the second sealhead is being decoupled from the tube, the seal loses sealing contact with the inner surface to enable the sealed pressure chamber to be depressurized.

Example 16 includes the air spring of Example 15, wherein the second sealhead and the tube are coupled by a threaded connection, and wherein the axial interface locking length is defined by a threaded overlap between the second sealhead and the tube.

Example 17 includes the air spring of Examples 15 or 16, wherein the inner surface of the tube has a lead-in between the first section and the second section.

Example 18 is an air spring for a bicycle component, the air spring comprising: a tube having a first end and a second end opposite the first end; a first sealhead coupled to the tube at or near the first end; a second sealhead coupled to the tube at or near the second end such that a sealed pressure chamber is formed in the tube between the first and second sealheads, the second sealhead coupled to the tube along an axial interface locking length; a piston in the sealed pressure chamber, the piston dividing the sealed pressure chamber into a first chamber and a second chamber; a rod coupled to the piston and extending through the second sealhead, the piston and the rod movable between a bottom-out position and a top-out position; and a piston seal coupled to the piston and in sealing contact with an inner surface of the tube, wherein the inner surface of the tube has a recess between the piston seal and the second sealhead, wherein the piston seal is axially spaced from the recess by a seal gap when the piston is in the top-out position, and wherein the seal gap is less than the axial interface locking length such that as the second sealhead is being decoupled from the tube, the piston seal at least partially overlaps with the recess and loses sealing contact with the inner surface of the tube to allow airflow from the first chamber to the second chamber before the second sealhead is fully decoupled from the tube.

Example 19 includes the air spring of Example 18, wherein the recess is a dimple.

Example 20 includes the air spring of Examples 18 or 19, wherein the second sealhead and the tube are coupled by a threaded connection, and wherein the axial interface locking length is defined by a threaded overlap between the second sealhead and the tube.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. An air spring for a bicycle component, the air spring comprising:
a tube having a first end and a second end opposite the first end;
a first sealhead coupled to the tube at or near the first end;
a second sealhead coupled to the tube at or near the second end such that a sealed pressure chamber is formed in the tube between the first and second sealheads, wherein the second sealhead and the tube are coupled along an axial interface locking length; and
a seal coupled to the second sealhead and in sealing contact with an inner surface of the tube, wherein the tube has a vent port extending between an inner surface and an outer surface of the tube, and wherein the seal is spaced from the vent port by a port seal gap that is less than the axial interface locking length such that as the second sealhead is being decoupled from the tube, the seal loses sealing contact with the inner surface to enable at least a portion of the sealed pressure chamber to be equalized with atmospheric air before the second sealhead is fully decoupled from the tube.

2. The air spring of claim 1, wherein the second sealhead and the tube are coupled by a threaded connection, and wherein the axial interface locking length is defined by a threaded overlap between the second sealhead and the tube.

3. The air spring of claim 2, wherein the inner surface of the tube has internal threads and an outer surface of the second sealhead has external threads that are meshed with the internal threads to form the threaded connection.

4. The air spring of claim 1, further including:
a piston in the sealed pressure chamber; and
a rod coupled to the piston.

5. The air spring of claim 4, wherein the rod extends through a channel in the second sealhead.

6. The air spring of claim 4, further including a piston seal coupled to the piston, the piston seal in sealing contact with the inner surface of the tube such that the piston seal divides the sealed pressure chamber into a first chamber between the piston seal and the first sealhead and a second chamber between the piston seal and the second sealhead.

7. The air spring of claim 6, wherein the inner surface of the tube has a dimple, and wherein the piston seal is spaced from the dimple by a dimple seal gap.

8. The air spring of claim 7, wherein the dimple seal gap is less than the axial interface locking length such that as the second sealhead is being removed from the tube, the piston seal at least partially overlaps with the dimple and loses sealing contact with the inner surface to enable airflow between the first and second chambers before the second sealhead is fully decoupled from the tube.

9. The air spring of claim 8, wherein the dimple is closer to the second end of the tube than the piston seal.

10. The air spring of claim 7, wherein the vent port is a first distance from the second end and the dimple is a second distance from the second end, the second distance being greater than the first distance.

11. The air spring of claim 1, further including a valve coupled to the first sealhead to enable a user to add air to the pressurized sealed chamber or vent air from the pressurized sealed chamber.

12. The air spring of claim 1, further including a seat clamp coupled to the first end of the tube, the seat clamp to couple to a seat of the bicycle.

13. The air spring of claim 1, wherein the sealed pressure chamber is filled with pressurized air.

14. The air spring of claim 1, wherein the seal is disposed in a seal gland formed in an outer surface of the second sealhead.

15. An air spring for a bicycle component, the air spring comprising:
a tube having a first end and a second end opposite the first end, a first section of the tube having a first inner diameter, a second section of the tube adjacent the second end having a second inner diameter that is larger than first inner diameter;
a first sealhead coupled to the tube at or near the first end;
a second sealhead coupled to the tube at or near the second end such that a sealed pressure chamber is formed in the tube between the first and second sealheads, the second sealhead and the tube coupled along an axial interface locking length; and
a seal coupled to the second sealhead and in sealing contact with an inner surface of the tube along the first section, wherein the tube has a vent port located along the second section, and wherein the seal is axially spaced from the second section by a port seal gap that is less than the axial interface locking length such that as the second sealhead is being decoupled from the tube, the seal loses sealing contact with the inner surface to enable the sealed pressure chamber to be depressurized.

16. The air spring of claim 15, wherein the second sealhead and the tube are coupled by a threaded connection, and wherein the axial interface locking length is defined by a threaded overlap between the second sealhead and the tube.

17. The air spring of claim 15, wherein the inner surface of the tube has a lead-in between the first section and the second section.

18. An air spring for a bicycle component, the air spring comprising:
a tube having a first end and a second end opposite the first end;
a first sealhead coupled to the tube at or near the first end;
a second sealhead coupled to the tube at or near the second end such that a sealed pressure chamber is formed in the tube between the first and second sealheads, the second sealhead coupled to the tube along an axial interface locking length;
a piston in the sealed pressure chamber, the piston dividing the sealed pressure chamber into a first chamber and a second chamber;
a rod coupled to the piston and extending through the second sealhead, the piston and the rod movable between a bottom-out position and a top-out position; and
a piston seal coupled to the piston and in sealing contact with an inner surface of the tube, wherein the inner surface of the tube has a recess between the piston seal and the second sealhead, wherein the piston seal is axially spaced from the recess by a seal gap when the piston is in the top-out position, and wherein the seal gap is less than the axial interface locking length such that as the second sealhead is being decoupled from the tube, the piston seal at least partially overlaps with the recess and loses sealing contact with the inner surface of the tube to allow airflow from the first chamber to the second chamber before the second sealhead is fully decoupled from the tube.

19. The air spring of claim 18, wherein the recess is a dimple.

20. The air spring of claim 18, wherein the second sealhead and the tube are coupled by a threaded connection, and wherein the axial interface locking length is defined by a threaded overlap between the second sealhead and the tube.
